(19) United States
(12) Patent Application Publication
(10) Pub. No.: US 2024/0116577 A1
(43) Pub. Date: Apr. 11, 2024

(54) High Clearance Floorboards for an All Terrain Vehicle (ATV)

(71) Applicant: Nicholas Jeffrey Guth, Palm Bay, FL (US)

(72) Inventor: Nicholas Jeffrey Guth, Palm Bay, FL (US)

(21) Appl. No.: 18/377,272

(22) Filed: Oct. 5, 2023

Related U.S. Application Data
(60) Provisional application No. 63/378,455, filed on Oct. 5, 2022.

(51) Int. Cl. B62D 25/20; B62D 27/06; B62D 29/04

(52) U.S. Cl. CPC B62D 25/20; B62D 27/065; B62D 29/043; B62D 29/048

(57) ABSTRACT

A high clearance floorboard apparatus for after-market installation on vehicles with clearance or tire-size restricting floorboards. The invention consists of a precision-cut and shaped metallic structure and a selection of fasteners enabling the structure to be secured to the vehicle's frame. The structure's shape is measured to allow higher clearance which enables larger tires to be installed on the vehicle and supporting the forces placed on it by the terrain and driver during operation. For the preferred embodiment, this structure is secured to the frame of the vehicle by fasteners customized for the qualities of both the structure and vehicle frame's material composition. In that embodiment, the fastener locations are designed to maintain structural integrity of the weaker material.

### FIELD OF THE INVENTION

The present invention relates generally to high clearance floorboards for vehicles. More specifically, the present invention relates to high clearance floorboards for ATVs (all-terrain vehicles) which normally only allow for limited tire sizes, such as those produced by the company Honda.

### BACKGROUND OF THE INVENTION

An all-terrain vehicle (ATV), also known as a light utility vehicle (LUV), a quad bike, or simply a quad, as defined by the American National Standards Institute (ANSI) is a vehicle that travels on low-pressure tires, with a seat that is straddled by the operator, along with handlebars for steering control. As the name implies, it is designed to handle a wider variety of terrain than most other vehicles. In other words, ATVs seat one rider and have a steering system with handlebars, etc., similar to a motorcycle, and is used in a wide range of ways, from leisure and sport riding to utility work in the agriculture industry, etc. When it comes to trucks, jeeps, ATV's and UTV's (utility terrain vehicles), the first modification people often make is to install larger tires. For many it is just for the look, and for others, it is for increased performance in ground clearance and traction. For most ATV/UTV drivers, the main functional reason for installing larger tires is to lift it higher for more ground clearance. With the chassis raised further from the ground, the center of gravity is also raised. A raised center of gravity can make any ATV/UTV unstable then it was stock while going through corners or traversing sideways on hillsides. To that end, installing a lift kit with a wider stance or a set of wheel spacers is the usual route followed by most ATV enthusiasts. However, installing a lift can be a cumbersome process.

An objective of the present invention is to provide users with a device, that allows users to run large tires on a tire-size limited ATV or “TSL-ATV,” such as those generally produced by the company Honda, without having to install a lift. Accordingly, the present invention is a floorboard that works in a stationary manner, which may be fastened up to the applicable machine to enable usage of larger wheels, and thus to provide a bigger ground clearance. The present embodiment discussed is primarily intended for a TSL-ATV produced by Honda but the invention should not be considered limited to the style of ATV produced by Honda.

### SUMMARY OF THE INVENTION

An objective of the present invention is to provide users with a device, that allows users to run large tires on a TSL-ATV without having to install a lift. To accomplish this, the present invention comprises a floorboard that works in a stationary manner, which may be fastened up to the applicable machine to enable usage of larger wheels, and thus to provide a bigger ground clearance. TSL-ATVs generally have specially designed floorboards that cater to only particularly sized tires and don't provide enough clearance for larger tires. To that end, the present invention comprises a modified floorboard design for TSL-ATVs, wherein the floorboards may be easily fastened to the frame of the machine. Further, the design provides enough clearance for larger wheels/tires and is easy to install. Thus, the present invention is a simple, cost effective, and efficient device that enables TSL-ATVs to run large tires without installing a lift system.

### BRIEF DESCRIPTION OF THE DRAWINGS

FIG. 1 is a top front perspective of an embodiment for the present invention.

FIG. 2 is a top rear perspective of an embodiment for the present invention.

FIG. 3 is a left-side perspective of an embodiment for the present invention.

FIG. 4 is a right-side perspective of an embodiment for the present invention.

FIG. 5 is a top plan of an embodiment for the present invention.

FIG. 6 is a bottom plan of an embodiment for the present invention.

FIG. 7 is a bottom left perspective of an embodiment for the present invention.

FIG. 8 is a bottom right perspective of an embodiment for the present invention.

### DETAIL DESCRIPTIONS OF THE INVENTION

All illustrations of the drawings are for the purpose of describing selected versions of the present invention and are not intended to limit the scope of the present invention.

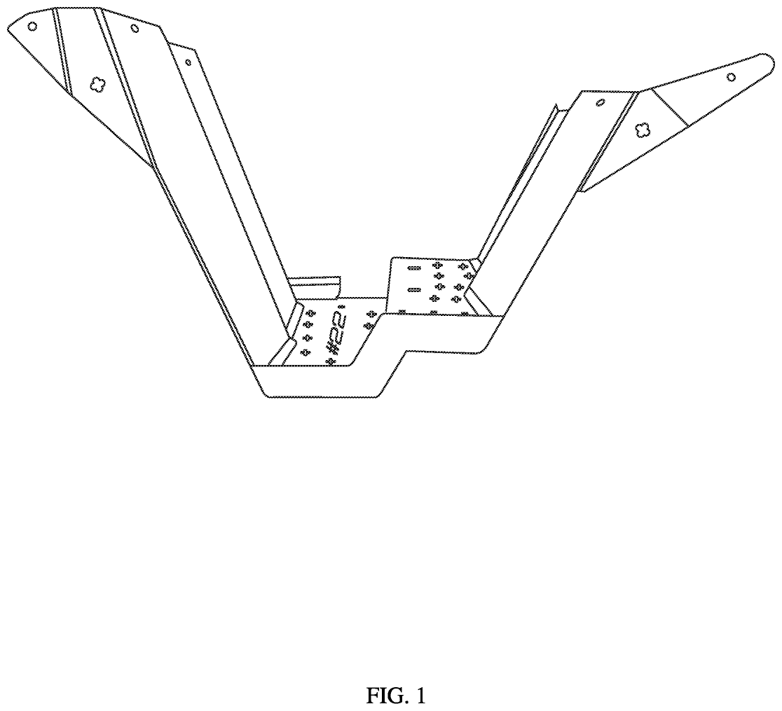

In reference to FIG. 1 through FIG. 8, the present invention is a high-clearance floorboard. An objective of the present invention is to provide users with a device, that allows users to run large tires on a TSL-ATV without having to install a lift. Accordingly, the present invention is a floorboard that works in a stationary manner, which may be fastened up to the applicable machine, to provide a wider clearance for bigger wheels. TSL-ATVs have a specially designed floorboard that allows room for only particularly sized tires and doesn't provide enough clearance for larger tires. The present invention comprises a modified floorboard design for TSL-ATVs, wherein the floorboards may be easily fastened to the frame of the machine. Further, the design provides enough clearance for larger wheels/tires and is easy to install. Thus, the present invention is a simple, cost effective, and efficient device that enables ATVs to run large tires without installing a lift system.

The following description is in reference to FIG. 1 through FIG. 8. According to a preferred embodiment, the present invention comprises a plurality of floorboard panels, a plurality of support pieces, a plurality of fastening apertures, and a plurality of fasteners. Preferably, the plurality of floorboard panels is welded together to create a floorboard of a specific shape that allows clearance for large wheels in a TSL-ATV. To accomplish this, the factory floorboards may be removed and replaced with the present invention. Usually, a TSL-ATV has a factory floorboard design, which drops vertically down along terminal sides of the floorboards that faces the wheels. However, in the present invention, the plurality of floorboard panels that face the wheels are inclined in a specific angle, that allows for more clearance for larger wheels. In other words, the present invention changes the angle of the plastic wheel hood of the vehicle, allowing larger tires to be used.

As seen in FIG. 1 through FIG. 8, each of the plurality of floorboard panels is angularly offset from a corresponding panel, wherein the corresponding panel is from the plurality of panels. This is so that the plurality of floorboard panels conforms to the specific shape of the frame of the vehicle, as well as provide necessary clearance without hindering the functional aspects of the vehicle. In the preferred embodiment, the plurality of floorboard panels is made of Aluminum, they are cut to the desired shape with the help of a fiber laser, and they are welded together to form the present invention. However, the plurality of floorboard panels may comprise any other material, components, arrangement of components, orientation, attachment means etc. that are known to one of ordinary skill in the art, as long as the intents of the present invention are not altered.

According to the preferred embodiment, the plurality of floorboard panels comprises a plurality of base panels and a plurality of lateral panels. Preferably, the plurality of lateral panels is laterally mounted onto terminal edges of the plurality of base panels. More specifically, a first set of lateral panels is mounted onto a first base panel and a second set of lateral panels is mounted onto a second base panel. Further, the first base panel is terminally connected to the second base panel, opposite to the second set of lateral panels. The first set of lateral panels and the second set of lateral panels are from the plurality of lateral panels, and the first base panel and the second base panel are from the plurality of base panels. It should be noted that, the plurality of lateral panels is inclined in such a way that, they allow clearance for larger wheels. In other words, the plurality of lateral panels that face a plurality of tires of an ATV, are angularly offset from a longitudinal axis of the plurality of tires. This arrangement is different from factory floorboards of a TSL-ATV.

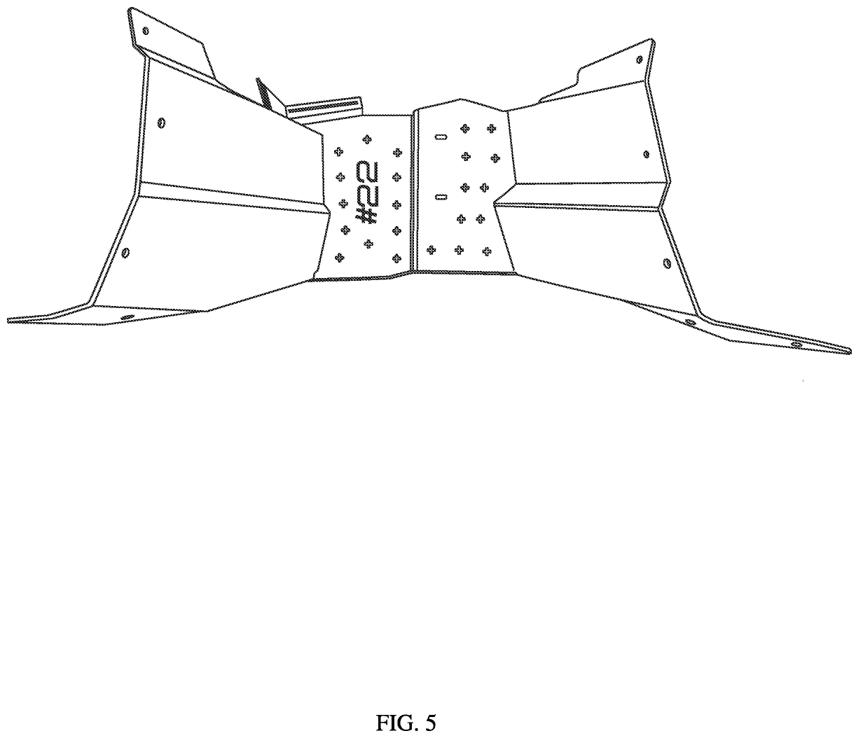

As seen in FIG. 5 through FIG. 8, the present invention comprises a plurality of air holes, wherein the plurality of air holes traverses through the plurality of base panels. Preferably, the plurality of air holes helps with preventing accumulation of mud, dirt, sand, snow etc. on the plurality of base panels. Further, the plurality of air holes may comprise any shape, size, location, arrangement pattern etc., as long as the objectives of the present invention are not altered.

In order to smoothly connect the high clearance floorboard to the vehicle or machine of choice, the present invention comprises the plurality of support pieces. Preferably, the plurality of support pieces is laterally mounted onto terminal edges of the plurality of floorboard panels. The plurality of support pieces is specifically shaped so as to latch onto and confirm to the specific shape of the vehicle of choice. In other words, the plurality of support pieces is welded to the plurality of floorboard panels, so as to enable latching or connection of the present invention to the frame of the machine. Preferably, the plurality of support pieces is made of steel, and they are welded to the plurality of floorboard panels. However, the plurality of support pieces may comprise any other material, size, shape etc. that are known to one of ordinary skill in the art, as long as intents of the present invention are fulfilled.

In order to effectively mount the present invention to the vehicle, the present invention comprises the plurality of fasteners and the plurality of fastening apertures. The plurality of fastening apertures traverses through the plurality of floorboard panels and the plurality of support pieces. Further, the plurality of fasteners is detachably connected between the vehicle, the plurality of floorboard panels, and the plurality of support pieces. Further, the plurality of fasteners is integrated between the plurality of fastening apertures and the plurality of floorboard panels. Preferably, the plurality of fasteners comprises nuts and bolts. However, the plurality of fasteners may comprise any other fastening technology that are known to one of ordinary skill in the art, as the intents of the present invention are not altered.

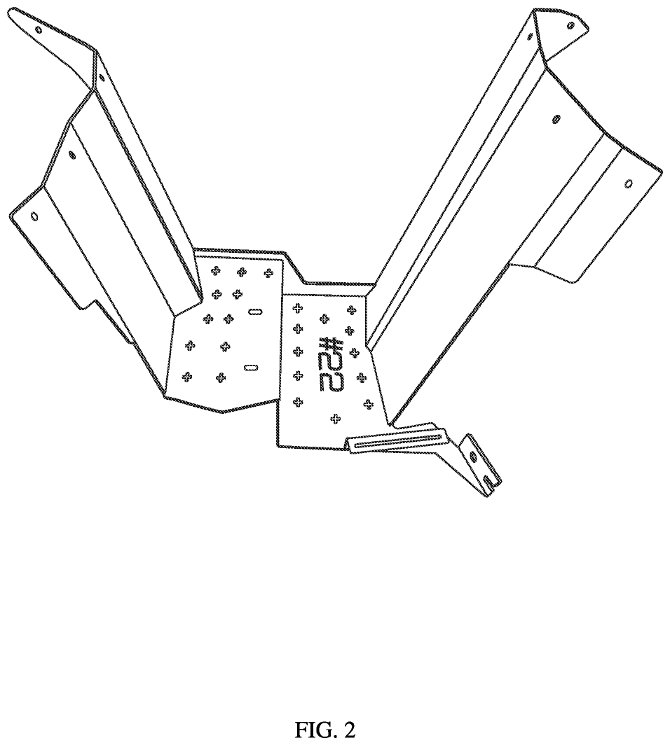

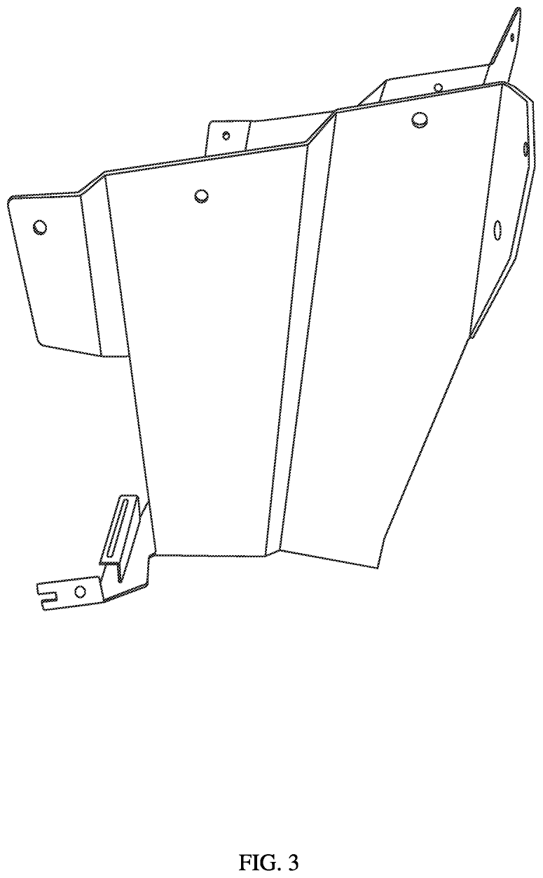

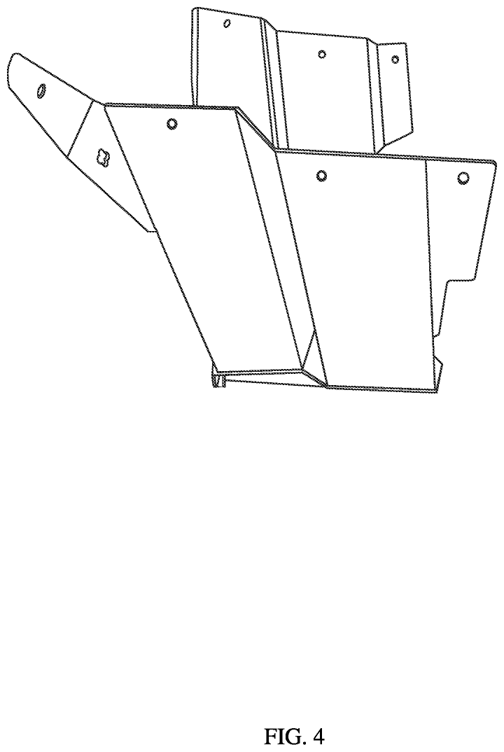

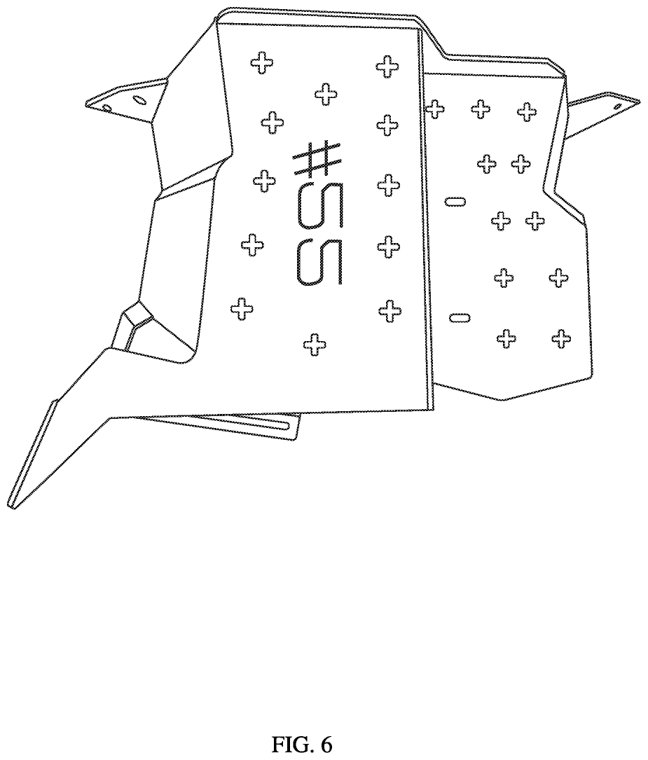

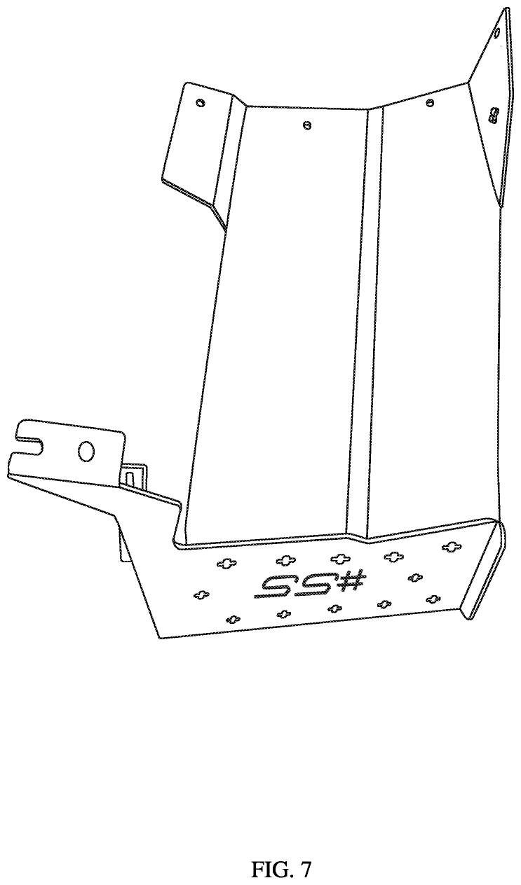

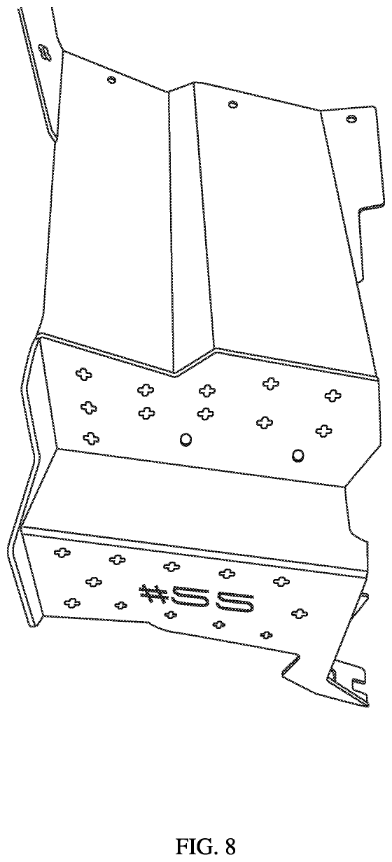

FIG. 1 through FIG. 8, are drawings which demonstrate different angles of an approach to the invention according to the preferred embodiment. FIG. 1 displays a top front perspective of an embodiment, relative to how a user would approach the vehicle after installation. This angle demonstrates the combined structure of the panels, support pieces, and several fastening apertures, including how they would be positioned to be fastened to the frame of the vehicle and the tapered angle which facilitates the higher clearance. FIG. 2 displays a top rear perspective, FIG. 3 displays a left-side perspective, and FIG. 4 displays a right-side perspective of an embodiment for the present invention relative to how a user would approach the vehicle after installation. These perspectives further demonstrate the structure of this embodiment and positioning of the fastening apertures. FIG. 5 displays a top plan while FIG. 6 displays a bottom plan of an embodiment for the present invention. These plans highlight the inclusion of air holes on the floorboard panels to facilitate cleaning and reduce the collection of foreign material in those areas. FIG. 7 displays a bottom left perspective while FIG. 8 displays a bottom right perspective of an embodiment for the present invention, further demonstrating the arrangement of pieces in the structure as well as showing the air holes.

Although the invention has been explained in relation to its preferred embodiment, it is to be understood that many other possible modifications and variations can be made without departing from the spirit and scope of the invention.

1. An apparatus comprising:
one or more floorboard panels;
one or more support pieces;
one or more fastening apertures;
one or more fasteners;
wherein the one or more floorboard panels, one or more support pieces, and one or more fastening apertures are combined into a vehicle floorboard structure for an all-terrain vehicle;
wherein the structure is shaped such that:
the lower surfaces of the structure provide elevated clearance above the vehicle's tires,
the upper surfaces of the structure provide a seating position for the feet of the vehicle's driver, and
the one or more fastening apertures are positioned to enable attachment to the all-terrain vehicle;
wherein the structure is secured to the all-terrain vehicle's frame by the one or more fasteners to the frame through the fastening apertures.

2. The apparatus of claim 1, wherein the floorboard panels are comprised of one or more metals.

3. The apparatus of claim 2, wherein the vehicle floorboard structure is combined by welding the components.

4. The apparatus of claim 2, wherein the one or more floorboard panels are laser-cut to provide the structure's shape.

5. The apparatus of claim 4, wherein one or more floor holes are laser-cut through both surfaces of the one or more floorboard panels.

6. The apparatus of claim 1, wherein the one or more floorboard panels are comprised of a carbon-fiber composite material.

7. The apparatus of claim 1, wherein the one or more fasteners are bolts paired with nuts.

8. The apparatus of claim 7, wherein the one or more fasteners are further joined with one or more washers between the bolt-head and fastening aperture.

9. The apparatus of claim 1, wherein the fastening apertures are placed at locations which correspond to fastening locations of a removed floorboard on the all-terrain vehicle's frame.

10. The apparatus of claim 1, wherein the all-terrain vehicle is produced by the company Honda.

11. The apparatus of claim 1, wherein the all-terrain vehicle is produced by the company SHERP.
